(19) United States
(12) Patent Application Publication
(10) Pub. No.: US 2020/0231910 A1
(43) Pub. Date: Jul. 23, 2020

(54) BLEACH OR DETERGENT COMPOSITION

(71) Applicant: RHODIA OPERATIONS, Paris (FR)

(72) Inventors: Bing HONG, Shanghai (CN); Alexander LERCH, Gelnhausen (DE); Armin T. LIEBENS, Shanghai (CN); Stéphane STREIFF, Shanghai (CN)

(21) Appl. No.: 16/483,206

(22) PCT Filed: Jan. 30, 2018
(86) PCT No.: PCT/CN2018/074541

§ 371 Date: Aug. 2, 2019

(30) Foreign Application Priority Data
Feb. 3, 2017 (CN) PCT/CN2017/072809

(51) Int. Cl. C11D 3/39; C11D 11/00; C11D 3/395; C11D 3/10

(52) U.S. Cl. CPC C11D 3/392; C11D 11/0023; C11D 3/10; C11D 3/3953; C11D 11/0017

(57) ABSTRACT

The invention relates to the use of specific amines as bleaching catalyst for detergent compositions and to bleach and detergent compositions containing these. The invention concerns also a formulation comprising at least a detergent, aspecific amine, and optionally a source ofhydrogen peroxide.

### CROSS-REFERENCE TO RELATED APPLICATION

The present application claims priority to International Application No. PCT/CN2017/072809 filed on 3 Feb. 2017, the whole content of this application being incorporated herein by reference.

### TECHNICAL FIELD

The invention relates to the use of specific amines as bleaching catalyst for detergent compositions and to bleach and detergent compositions containing these. The invention concerns also a formulation comprising at least a detergent, a specific amine, and optionally a source of hydrogen peroxide.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Peroxide bleaching agents for use in laundering have been known for many years. Such agents are effective in removing stains, such as tea, fruit and wine stains, from clothing at or near boiling temperatures. The efficacy of peroxide bleaching agents drops off sharply at temperatures below 60° C.

It is known that many transition metal ions catalyst the decomposition of H₂O₂ and H₂O₂-liberating percompounds, such as sodium perborate. It has also been suggested that transition metal salts together with a chelating agent can be used to activate peroxide compounds so as to make them usable for satisfactory bleaching at lower temperatures.

For a transition metal to be useful as a bleach catalyst in a detergent bleach composition, the transition metal compound must not unduly promote peroxide decomposition by non-bleaching pathways and must be hydrolytically and oxidatively stable.

Hitherto the most effective peroxide bleach catalysts are based on iron, cobalt or manganese as the transition metal, such as manganese-triazacyclononane complexes, manganese Schiff-Base complexes, manganese cross-bridged macrocyclic complexes, manganese complexes with 2,2′:6,2″-terpyridine, iron complexes with tris(pyridin-2ylmethyl)amine (TPA), iron complexes with pentadentate nitrogen-donor ligands and cobalt complexes with polypyridineamine ligands. The addition of catalysts based on the transition metal cobalt or manganese to detergent formulations is, however, a less acceptable route as judged from an environmental point of view.

European Patent Specifications Nos. 458 397 and 458 398 a series of manganese complexes with dinuclear manganese surrounded by coordinating ligands, especially 1,4,7-trimethyl-1,4,7-triazacyclononane (Me₃-TACN), having oxygen bridges between the metal centers. These complexes are extremely active, even at low temperatures in catalysing peroxy compounds. A wide variety of laundry stains are removable through these materials. However, the cost of the dinuclear manganese complex catalysts is extremely high and on the other hand, the cotton fabric was easily damaged by using this dinuclear manganese complexes.

Additionally, it would be desirable to find alternative catalysts that are effective with lower levels of peroxy compounds (e.g. perborate) and that would improve performance in removing a wide range of stains.

### Invention

We have now discovered a certain class of amine compounds which fulfil the demands of stability, both during the washing process and in the dispenser of the washing machine, are extremely active, for catalyzing the bleaching action of a source of hydrogen peroxide on a wide variety of stains, notably at low to medium temperatures of 10-40° C.

The present invention concerns then a composition, notably a bleach or detergent composition, comprising at least:

a) a compound of formula (I)

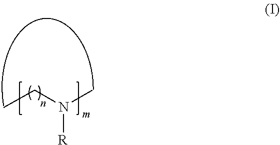

wherein:
R is a hydrocarbyl radical, and each of the R groups may be the same or different
n is 1, 2 or 3
m is 2, 3, 4 or 5; and
   b) a source of hydrogen peroxide.

We have also found that the compounds of formula (I) enhance the bleaching effect of bleach or detergent compositions. In particular, they enhance the bleaching effect of bleach or detergent compositions comprising a source of hydrogen peroxide, such as peroxy compounds or peracids, especially for hydrophobic/lipophilic stains and also for hydrophilic/lipophobic stains, notably on textiles. It also appears that the combination of the present invention permits to obtain very good bleaching properties while lower amount of compounds of formula (I) in comparison with other amines used on the market. Furthermore, the composition of the invention permits to obtain very good bleaching properties and without damaging the fabrics in comparison with the dinuclear manganese complex catalysts. It also appears that the combination of the invention permits to obtain significant bleaching properties without the use of detergent.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

Another object of the invention is to provide an improved bleaching or textile detergent composition which is effective at low to medium temperatures of 10-40° C. Still another object of the invention is to provide new and improved bleaching or textile detergent compositions which are especially effective for washing at lower temperatures. Yet another object of the invention is to provide a new and aqueous laundry wash media containing new and improved detergent bleach formulations.

The present invention also concerns the use of a compound of formula (I) for treating a substrate, notably for bleaching a substrate. The present invention also concerns a method for treating a substrate, notably bleaching a substrate, comprising applying to the substrate, in an aqueous medium, a composition comprising at least a compound of formula (I).

The invention also concerns a method for washing tableware in a domestic automatic dishwashing appliance, comprising treating the soiled tableware in an automatic dishwasher with a composition of the invention. The present invention also relates to automatic dishwashing rinse aid compositions and methods for treating tableware in a domestic automatic dishwashing appliance during a rinse cycle.

The invention concerns also a formulation comprising at least a detergent, a compound of formula (I), and optionally a source of hydrogen peroxide.

Other characteristics, details and advantages of the invention will emerge even more fully upon reading the description which follows.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

As used herein, “weight percent,” “wt %,” “percent by weight,” “% by weight,” and variations thereof refer to the concentration of a substance as the weight of that substance divided by the total weight of the composition and multiplied by 100.

It should be noted that in specifying any range of concentration, weight ratio or amount, any particular upper concentration, weight ratio or amount can be associated with any particular lower concentration, weight ratio or amount, respectively.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “consisting of” means the embodiment necessarily includes the listed components only and no other unlisted components are present.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of 120° C. to 150° C. should be interpreted to include not only the explicitly recited limits of 120° C. to 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “between” should be understood as being inclusive of the limits.

It is specified that, in the continuation of the description, unless otherwise indicated, the values at the limits are included in the ranges of values which are given. It should be noted that in specifying any range of concentration, any particular upper concentration can be associated with any particular lower concentration.

As used herein, the term “hydrocarbon group” refers to a group mainly consisting of carbon atoms and hydrogen atoms, which group may be saturated or unsaturated, linear, branched or cyclic, aliphatic or aromatic. The term “hydrocarbyl” used in the description and the claims describes radicals which are based on hydrocarbons with the stated number of carbon atoms and which may be pure hydrocarbon radicals but may also have substituents or functions. Hydrocarbon groups of the present invention may be alkyl groups, alkenyl groups, alkynyl groups, aryl groups, alkylaryl groups, aryalkyl groups, heterocyclic groups, and/or alkylheterocyclic groups.

As used herein, the terminology “(Cₙ-Cₘ)” in reference to an organic group, wherein n and m are each integers, indicates that the group may contain from n carbon atoms to m carbon atoms per group.

As used herein, “alkyl” should be construed under the ordinary meaning. Alkyl groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

As used herein, “alkenyl” or “alkenyl group” refers to an aliphatic hydrocarbon radical which can be straight or branched, containing at least one carbon-carbon double bond. Examples of alkenyl groups include, but are not limited to, ethenyl, propenyl, n-butenyl, i-butenyl, 3-methylbut-2-enyl, n-pentenyl, heptenyl, octenyl, decenyl, and the like. The term “alkynyl” refers to straight or branched chain hydrocarbon groups having at least one triple carbon to carbon bond, such as ethynyl.

The term “aryl group” includes unsaturated and aromatic cyclic hydrocarbons as well as unsaturated and aromatic heterocycles containing one or more rings. Aryl groups may also be fused or bridged with alicyclic or heterocyclic rings that are not aromatic so as to form a polycycle, such as tetralin. An “arylene” group is a divalent analog of an aryl group.

The term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated. Additionally, heterocyclic groups, such as pyrrolyl, pyridyl, isoquinolyl, quinolyl, purinyl, and furyl, may have aromatic character, in which case they may be referred to as “heteroaryl” or “heteroaromatic” groups.

### DETAILS OF THE INVENTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

### Compound of Formula (I)

R may be a C₁-C₃₀-hydrocarbyl radical, preferably a C₁-C₁₅-hydrocarbyl radical.

R may notably be C₁-C₃₀-alkyl radicals, preferably C₁₋₂₀-alkyl radicals, particularly preferably C₁₋₁₀-alkyl radicals, which can be straight-chain or branched and may carry one or more substituents. R may be C₂₋₃₀-alkenyl radicals, preferably C₂₋₂₀-alkenyl radicals, particularly preferably C₂₋₁₀-alkenyl radicals, which can be straight-chain or branched and may carry one or more substituents and/or one or more functions. R may also be C₅₋₁₈-cycloalkyl radicals which may have branches. R may furthermore be C₇₋₁₈-aralkyl radicals in which an aromatic radical is bonded via an alkyl group to the amine nitrogen atom. R may also be C₇₋₁₈-heteroalkyl radicals or C₆₋₁₈-aryl radicals or C₃₋₁₈-heteroaryl radicals, with, in the last-mentioned compounds, an aromatic radical being directly linked to the amine nitrogen atom. R may furthermore carry one or more, preferably zero or one, substituents such as hydroxyl groups, C₁₋₄-alkoxy radicals, amino groups, C₁₋₄-alkylamino radicals, (di-C₁₋₄-alkyl)amino radicals, chlorine atoms, bromine atoms, nitro groups, cyano groups, C₁₋₄-alkylthio radicals, C₁₋₄-alkylsulfonyl radicals, carbonyl radicals, carboxyl groups, sulfo groups, sulfate groups, carboxy-C₁₋₄-alkyl radicals, carbamoyl radicals or phenyl, tolyl or benzyl radicals.

The carbon chains of R may furthermore be interrupted by oxygen atoms, imino groups, C₁₋₄-alkylimino radicals, iminocarbonyl radicals, oxycarbonyl radicals or carbonyl radicals.

R is preferably a C₁₋₅-hydrocarbyl radical, preferably a methyl radical.

Compounds of formula (I) may be chosen in the group constituted by triazacycloalkanes and tetraazacycloalkanes.

Compounds of formula (I) may be chosen in the group constituted by: 1,3,5-trimethyl-1,3,5-triazacyclohexane; 1,3,5-trimethyl-1,3,5-triazepane; 1,3,5-trimethyl-1,3,5-triazocane; 1,3,5,7-tetramethyl-1,3,5-triazocane; 1,3,6-trimethyl-1,3,6-triazocane; 1,3,5-trimethyl-1,3,5-triazonane; 1,3,6-trimethyl-1,3,6-triazonane; 1,3,6,8-tetramethyl-1,3,6-triazonane; 1,4,7-trimethyl-1,4,7-triazacyclononane; 1,3,5-trimethyl-1,3,5-triazecane; 1,3,6-trimethyl-1,3, 6-triazecane; 1,3,7-trimethyl-1,3,7-triazecane; 1,3,5,7-tetramethyl-1,3,7-triazecane; 1,3,5,7,9-pentamethyl-1,3,7-triazecane; 1,3,5,7-tetramethyl-1,3,5-triazecane; 1,4,7-trimethyl-1,4,7-triazecane; 1,4,7,9-tetramethyl-1,4,7-triazecane; 1,4,7-trimethyl-1,4,7-triazacycloundecane;

1,4,8-trimethyl-1,4,8-triazacycloundecane; 1,4,6,8-tetramethyl-1,4,8-triazacycloundecane; 1,4,7-trimethyl-1,4,7-triazacyclododecane; 1,4,7,10-tetramethyl-1,4,7,10-tetraazacyclododecane; 1,4,7,10-tetramethyl-1,4,7-triazacyclododecane; 1,4,8-trimethyl-1,4,8-triazacyclododecane; 1,5,9-trimethyl-1,5,9-triazacyclododecan; 1,3,5,9-tetramethyl-1,5, 9-triazacyclododecane; and 2-methyl-1,4,7-trimethyl-1,4,7-triazacyclononane.

The compound of formula (I) may be present in the composition in an amount from 0.0001 to 1.0% by weight, preferably from 0.0001 to 0.5% by weight, more preferably from 0.0001 to 0.01% by weight, with respect to the total weight of the composition; notably 0.0001, 0.0005, 0.001, 0.005, 0.01, 0.05, 0.1, 0.5 and 1% by weight or any range comprised between these values.

### Source of Hydrogen Peroxide

Hydrogen peroxide sources are well known in the art and they usually refer to peroxide, hydrogen peroxide-liberating or -generating compounds. Source of hydrogen peroxide is preferably chosen in the group constituted by: alkali metal peroxides, organic peroxides, such as urea peroxide, inorganic persalts, such as the alkali metal perborates, percarbonates, perphosphates, persulphates and peroxyacids and their salts, and their precurors. Mixtures of two or more such compounds may also be suitable. Particularly preferred are sodium percarbonate and sodium perborate and, especially, sodium perborate monohydrate. Sodium perborate monohydrate is preferred to tetrahydrate because of its excellent storage stability while also dissolving very quickly in aqueous bleaching solutions. Sodium percarbonate may be preferred for environmental reasons. These bleaching compounds may be utilized alone or in conjunction with a peroxyacid bleach precursor.

The peroxy compound bleaches which can be utilized in the present invention include hydrogen peroxide, hydrogen peroxide-liberating compounds, hydrogen peroxide-generating systems, peroxyacids and their salts, and peroxyacid bleach precursors and mixtures complexes.

Peroxyacid bleach precursors are known and amply described in literature, such as in the GB Patents 836,988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Another useful class of peroxyacid bleach precursors is that of the quaternary ammonium substituted peroxyacid precursors as disclosed in U.S. Pat. Nos. 4,751,015 and 4,397,757, in EP-A-284292 and EP-A-331,229. Examples of peroxyacid bleach precursors of this class are: 2-(N,N,N-trimethyl ammonium) ethyl sodium-4-sulphophenyl carbonate chloride—(SPCC); N-octyl,N,N-dimethyl-N10-carbophenoxy decyl ammonium chloride—(ODC); 3-(N,N,N-trimethyl ammonium) propyl sodium-4-sulphophenyl carboxylate; and N,N,N-trimethyl ammonium toluyloxy benzene sulphonate.

Of the above classes of bleach precursors, the preferred classes are the esters, including acyl phenol sulphonates and acyl alkyl phenol sulphonates; acylamides; and the quaternary ammonium substituted peroxyacid precursors.

Highly preferred activators include sodium-4-benzoyloxy benzene sulphonate; N,N,N′,N′-tetraacetyl ethylene diamine; sodium-1-methyl-2-benzoyloxy benzene-4-sulphonate; sodium-4-methyl-3-benzoyloxy benzoate; SPCC; trimethyl ammonium toluyloxy benzene sulphonate; sodium nonanoyloxybenzene sulphonate and sodium 3,5,5,-trimethyl hexanoyloxybenzene sulphonate.

Organic peroxyacids may also be suitable as the peroxy bleaching compound, such as monoperoxy acids and diperoxyacids.

Typical monoperoxy acids useful herein include, for example: peroxybenzoic acid and ring-substituted peroxybenzoic acids, eg peroxy-.alpha.-naphthoic acid; aliphatic, substituted aliphatic and arylalkyl monoperoxyacids, e.g. peroxylauric acid, peroxystearic acid and N,N-phthaloylaminoperoxy caproic acid (PAP); and 6-octylamino-6-oxo-peroxyhexanoic acid.

Typical diperoxyacids useful herein include, for example: 1,12-diperoxydodecanedioic acid (DPDA), 1,9-diperoxyazelaic acid, diperoxybrassilic acid; diperoxysebasic acid and diperoxyisophthalic acid; 2-decyldiperoxybutane-1,4-diotic acid; and 4,4′-sulphonylbisperoxybenzoic acid.

In particular, the composition can be formulated to contain, for example, from 1 to 30% by weight, preferably from 5 to 25% by weight, of source of hydrogen peroxide, with respect to the total weight of the composition. Peroxyacids may be utilized in somewhat lower amounts, for example from 1 to 15% by weight, preferably from 2 to 10% by weight. Peroxyacid precursors may be utilized in combination with a peroxide compound in approximately the same level as peroxyacids, i.e. 1 to 15% by weight, preferably from 2 to 10% by weight.

### Composition

A composition of the invention, notably a bleach or textile detergent composition, may be formulated by combining effective amounts of the components. The term “effective amounts” as used herein means that the ingredients are present in quantities such that each of them is operative for its intended purpose when the resulting mixture is combined with water to form an aqueous medium which can be used to wash and clean clothes, fabrics and other articles.

Composition of the invention may then further comprise water.

The pH of the composition may be from 7 to 12, preferably from 9 to 11.

The composition of the invention may further comprise a detergent. Detergents are usually defined as a surfactant or a mixture of surfactants having cleaning properties in dilute solutions. The compounds of the invention are compatible with substantially any known and common surface-active agents and detergency builder materials. The surfactant may be naturally derived, such as soap, or a synthetic material selected from anionic, nonionic, amphoteric, zwitterionic, cationic actives and ‘mixtures thereof. Many suitable actives are commercially available and are amply described in literature. The total level of the surfactant may range up to 50% by weight, preferably being from 1 to 40% by weight of the composition, most preferably 2 to 25% by weight.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those esters of the higher alcohols derived from tallow or coconut oil and synthetic alcohols derived from petroleum; sodium coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralized with sodium hydroxide; sodium and ammonium salts of fatty acid amides of methyl taurine; alkane monosulphonates such as those derived by reacting alpha-olefins (C₈-C₂₀) with sodium bisulphite and those derived by reacting parafins with SO₂ and Cl₂ and then hydrolyzing with a base to produce a random sulphonate; sodium and ammonium C₇-C₁₂ dialkyl sulfosuccinates; and olefin sulphonates, which term is used to describe the material made by reacting olefins, particularly C₁₀-C₂₀ alpha olefins with SO₃ and then neutralizing and hydrolysing the reaction product. The preferred anionic detergent compounds are sodium (C₁₁-C₁₅) alkylbenzene sulphonates, sodium (C₁₆-C₁₈) alkyl sulphates and sodium (C₁₆-C₁₈) alkyl ether sulphates.

Examples of suitable nonionic surfactant compounds which may be used, include in particular the reaction products of alkylene oxides, usually ethylene oxide, with alkyl (C₆-C₂₂) phenols, generally 5-25 EO, i.e. 5-25 units of ethylene oxides per molecule; the condensation products of aliphatic (C₈-C₁₈) primary or secondary linear or branched alcohols with ethylene oxide, generally 3-30 EO, and products made by condensation of ethylene oxide with the reaction products of propylene oxide and ethylene diamine. Other so-called nonionic surfactants include alkyl polyglycosides, long chain tertiary amine oxides, long chain tertiary phosphine oxides and dialkyl sulphoxides.

Soaps may also be incorporated in the compositions of the invention, preferably at a level of less than 25% by weight. They are particularly useful at low levels in binary (soap/anionic) or ternary mixtures together with nonionic or mixed synthetic anionic and nonionic compounds. Soaps which are used, are preferably the sodium, or, less desirably, potassium salts of saturated or unsaturated C₁₀-C₂₄ fatty acids or mixtures thereof. The amount of such soaps can be varied between 0.5 and 25% by weight, with lower amounts of 0.5 to 5% by weight being generally sufficient for lather control. Amounts of soap between 2 and 20% by weight, especially between 5 and 10% by weight, are used to give a beneficial effect on detergency. This is particularly valuable in compositions used in hard water when the soap acts as a supplementary builder.

The detergent compositions of the invention will normally also contain a detergency builder. Builder materials may be selected from calcium sequestrant materials, precipitating materials, calcium ion-exchange materials, such as aluminosilicates, silicates, carbonates and phosphates. Examples of suitable inorganic builders are aluminosilicates with ion-exchanging properties, such as zeolites. Various types of zeolites are suitable, especially zeolites A, X, B, P, MAP and HS in their Na form, or in forms in which Na is partly replaced by other cations, such as Li, K, Ca, Mg or ammonium. Suitable zeolites are described, for example, in EP-A 038 591, EP-A 021 491, EP-A 087 035, U.S. Pat. No. 4,604 224, GB-A2 013 259, EP-A 522 726, EP-A 384 070 and WO 94/24 251.

Other suitable inorganic builders are, for example, amorphous or crystalline silicates, such as amorphous disilicates, crystalline disilicates such as the sheet silicate SKS-6 (manufactured by Essential Ingredients, Inc.). The silicates can be employed in the form of their alkali metal, alkaline earth metal or ammonium salts. Na, Li and Mg silicates are preferably employed.

These builder materials may be present at a level of, for example, from 5 to 80% by weight, preferably from 10 to 60% by weight.

The composition may also contain one or more bleach stabilizers. These comprise additives able to adsorb, bind or complex traces of heavy metals. Examples of additives which can be used according to the invention with a bleach-stabilizing action are polyanionic compounds, such as polyphosphates, polycarboxylates, polyhydroxypolycarboxylates, soluble silicates as completely or partially neutralized alkali metal or alkaline earth metal salts, in particular as neutral Na or Mg salts, which are relatively weak bleach stabilizers. Examples of strong bleach stabilizers which can be used according to the invention are complexing agents such as ethylenediaminetetraacetate (EDTA), nitrilotriacetic acid (NTA), methyl-glycinediacetic acid (MGDA), [beta]-alaninediacetic acid (ADA), ethylenediamnine-N,N′-disuccinate (EDDS) and phosphonates such as ethylenediaminetetramethylenephosphonate, diethylenetriaminepentamethylenephosphonate or hydroxyethylidene-1,1-diphosphonic acid in the form of the acids or as partially or completely neutralized alkali metal salts. The complexing agents are preferably employed in the form of their Na salts.

Apart from the components already mentioned, the compositions of the invention can contain any of the conventional additives in the amounts in which such materials are normally employed in fabric washing detergent compositions. Examples of these additives include leather boosters, such as alkanolamides, particularly the monoethanol amides derived from palmkernel fatty acids and coconut fatty acids, lather depressants, such as alkyl phosphates and silicones, anti-redeposition agents, such as sodium carboxymethyl cellulose and alkyl or substituted alkyl cellulose ethers, other stabilizers, such as ethylene diamine tetraacetic acid and the phosphonic acid derivatives, fabric softening agents, inorganic salts, such as sodium sulphate, and, usually present in very small amounts, fluorescent agents, perfumes, corrosion inhibitors, enzymes, such as proteases, cellulases, lipases, amylases and oxidases, germicides and colorants.

The detergent compositions of the present invention may additionally comprise one or more enzymes, which provide cleaning performance, fabric care and/or sanitation benefits. Said enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press.

Compositions of the invention formulated as free-flowing particles, e.g. in powdered or granulated form, can be produced by any of the conventional techniques employed in the manufacture of detergent compositions, for instance by slurry-making, followed by spray-drying to form a detergent base powder to which the heat-sensitive ingredients can be added as dry substances.

It will be appreciated, however, that the compositions can itself be made in a variety of other ways, such as the so-called part-part processing, non-tower route processing, dry-mixing, agglomeration, granulation, extrusion, compacting and densifying processes etc., such ways being well known to those skilled in the art.

The compositions of the invention can also contain any of the conventional additives in the amounts in which such materials are normally employed in dishwashing compositions.

In some embodiments, the dishwashing compositions can comprise a chelator, such as the sodium citrate, EDTA, trisodium methylglycinediacetate (MGDA), Sodium tripolyphosphate, N,N-Dicarboxymethyl glutamic acid tetrasodium salt (GLDA).

In some embodiments, the dishwashing compositions can comprise a builder, such as sodium silicate, sodium carbonate.

In some embodiments, the dishwashing compositions can comprise a filler, such as sodium sulfate, ammonium sulfate.

In some embodiments, the dishwashing composition can comprise a bleach agent, such as the chlorine, hydrogen peroxide, sodium percabonate.

In some embodiments, the dishwashing composition can comprise an enzyme, such as the protease and amylase.

In some embodiments, the dishwashing composition can comprise a dispersant agent, such as the polyacrylate, polyethylene glycol.

In some embodiments, the dishwashing composition can comprise a surfactant, such as the non-ionic surfactants, anionic surfactants.

It should be understood by the skilled person the chelator, builder, filler, bleach agent, enzyme, dispersant and surfactant can be used solely or in the form of any combination for preparing the dishwashing composition.

Preferably, the composition of the invention is substantially free or, in some cases, completely free of any transition metal catalysts. As used herein, the term “transition metal catalysts” refers to catalysts carrying a transition metal, such as notably iron, cobalt or manganese, such as for instance transition metal complex catalyst, notably manganese-triazacyclononane complexes, manganese Schiff-Base complexes, manganese cross-bridged macrocyclic complexes, manganese complexes with 2,2′:6,2″-terpyridine, iron complexes with tris(pyridin-2ylmethyl)amine (TPA), iron complexes with pentadentate nitrogen-donor ligands and cobalt complexes with polypyridineamine ligands. As used herein, the term “substantially free” when used with reference to the absence of transition metal catalysts in the composition means that the composition comprises from 0 to 0.001% by weight, preferably from 0 to 0.0005% by weight of transition metal catalysts, based on the total weight of the composition. As used herein, the term “completely free” when used with reference to the absence of transition metal catalyst in the composition of the present invention, means that the composition comprises no transition metal catalyst at all.

Composition of the invention preferably comprises from 0 to 0.001% by weight, preferably from 0 to 0.0005% by weight of transition metal catalysts, based on the total weight of the composition.

### Applications

The present invention also concerns the use of a compound of formula (I) for treating a substrate, notably for bleaching a substrate. The present invention also concerns a method for treating a substrate, notably bleaching a substrate comprising applying to the substrate, in an aqueous medium, a composition comprising at least a compound of formula (I).

The present invention extends to a method of bleaching a substrate comprising applying to the substrate, in an aqueous medium, the bleaching composition according to the present invention.

Any suitable substrate that is susceptible to bleaching or one that one might wish to subject to bleaching may be used, such as a textile for instance. Preferably the textile is a laundry fabric or garment.

In a preferred embodiment, the method is carried out on a laundry fabric using an aqueous treatment liquor. In particular, the treatment may be effected in a wash cycle for cleaning laundry. More preferably, the treatment is carried out in an aqueous detergent bleach wash liquid.

The organic substances can be contacted with the textile fabric in any conventional manner. For example it may be applied in dry form, such as in powder form, or in a liquor that is then dried, for example in an aqueous spray-on fabric treatment fluid or a wash liquor for laundry cleaning, or a non-aqueous dry cleaning fluid or spray-on aerosol fluid.

In a particularly preferred embodiment the method according to the present invention is carried out on a laundry fabric using aqueous treatment liquor. In particular the treatment may be effected in, or as an adjunct to, an essentially conventional wash cycle for cleaning laundry. More preferably, the treatment is carried out in an aqueous detergent wash liquor. The organic substance can be delivered into the wash liquor from a powder, granule, pellet, tablet, block, bar or other such solid form. The solid form can comprise a carrier, which can be particulate, sheet-like or comprise a three-dimensional object. The carrier can be dispersible or soluble in the wash liquor or may remain substantially intact. In other embodiments, the organic substance can be delivered into the wash liquor from a paste, gel or liquid concentrate.

In the alternative, the organic substance can be presented in the form of a wash additive that preferably is soluble. The additive can take any of the physical forms used for wash additives, including powder, granule, pellet, sheet, tablet, block, bar or other such solid form or take the form of a paste, gel or liquid. Dosage of the additive can be unitary or in a quantity determined by the user. While it is envisaged that such additives can be used in the main washing cycle, the use of them in the conditioning or drying cycle is not hereby excluded.

The present invention is not limited to those circumstances in which a washing machine is employed, but can be applied where washing is performed in some alternative vessel. In these circumstances it is envisaged that the organic substance can be delivered by means of slow release from the bowl, bucket or other vessel which is being employed, or from any implement which is being employed, such as a brush, bat or dolly, or from any suitable applicator.

The invention also concerns a method washing tableware in a domestic automatic dishwashing appliance, comprising treating the soiled tableware in an automatic dishwasher with a composition of the invention. The present invention also relates to automatic dishwashing rinse aid compositions and methods for treating tableware in a domestic automatic dishwashing appliance during a rinse cycle.

Automatic dishwashing with bleaching chemicals is different from fabric bleaching. In automatic dishwashing, use of bleaching chemicals involves promotion of soil removal from dishes, though soil bleaching may also occur. Additionally, soil antiredeposition and anti-spotting effects from bleaching chemicals would be desirable. Some bleaching chemicals, (such as a hydrogen peroxide source, alone or together with tetraacetylethylenediamine, TAED) can, in certain circumstances, be helpful for cleaning dishware, but this technology gives far from satisfactory results in a dishwashing context: for example, ability to remove tough tea stains is limited, especially in hard water, and requires rather large amounts of bleach. Other bleach activators developed for laundry use can even give negative effects, such as creating unsightly deposits, when put into an automatic dishwashing product, especially when they have overly low solubility. Other bleach systems can damage items unique to dishwashing, such as silverware, aluminium cookware or certain plastics.

The composition of the invention may also be applied in the peroxide oxidation of a broad range of organic molecules such as olefins, alcohols, aromatic ethers, sulphoxides and various dyes, and also for inhibiting dye transfer in the laundering of fabrics.

The invention concerns also a formulation, notably a solid composition, comprising at least a detergent, a compound of formula (I), and optionally a source of hydrogen peroxide. Said composition may comprise from 0.1 to 2% by weight of compound of formula (I) with respect to the total weight of the composition. Said formulation may comprise from 0 to 0.01% by weight, preferably 0 to 0.0001% by weight of a transition metal catalysts, with respect to the total weight of the composition.

The invention also concerns a method for treating a substrate, notably for bleaching a substrate, comprising at least:
a) having available a composition comprising at least a detergent and a compound of formula (I), notably in a solid form,
b) having available a source of hydrogen peroxide, separate from the composition a)
c) bringing the composition a) extemporaneously into contact with source of hydrogen peroxide, notably under conditions favourable for the solubilization and/or dispersion of the composition a) in a liquid medium to obtain a mixture, and
d) bringing the mixture of c) into contact with the substrate.

The invention also concerns an extemporaneous composition comprising at least:
a first composition comprising at least a detergent and a compound of formula (I), notably in a solid form, and
a second composition comprising at least a source of hydrogen peroxide, separate from the first composition; the second composition being capable of being mixed with the first composition.

Such an extemporaneous composition may advantageously combine the first and second compositions separately, in a single packaging.

Should the disclosure of any patents, patent applications, and publications which are incorporated herein by reference conflict with the description of the present application to the extent that it may render a term unclear, the present description shall take precedence.

### Experimental Part

The disclosure will now be illustrated with working examples, which is intended to illustrate the working of disclosure and not intended to take restrictively to imply any limitations on the scope of the present disclosure. Other examples are also possible which are within the scope of the present disclosure.

Reference products:

### Tetraacetylethylenediamine (TAED): CAS 10543-57-4

1,4,7-trimethyl-1,4,7-triazacyclononane (TMTACN): CAS 96556-05-7
1,4,7,10-Tetramethyl-1,4,7,10-tetraazacyclododecan (TMTACDD): CAS 76282-33-2
1,3,5-Trimethyl-1,3,5-triazinane (TMTA): CAS 108-74-7
Di[manganese (1+)], bis(octahydro-1,4,7-trimethyl-1H-1,4,7-triazonine kN¹, kN⁴, kN⁷)-tri-μ-oxo-, bis[ethanoate (1−)](Dragon complex): CAS 916075-10-0
Sodium percarbonate: CAS 15630-89-4
Trisodium citrate hexahydrate: CAS 6858-44-2
Sodium carbonate: CAS 497-19-8
Sodium slicate: CAS 6834-92-0
Sodium sulfate: CAS 7757-82-6

### EXAMPLE 1

Into a beaker with 1L hard water (250 mg Ca/L) at 40° C., standard detergent GB/T 13174-2008 (2.0 g) was added and the mixture was stirred for 3 mins, at a temperature of 40° C. The amine compound (10 mg) and sodium percarbonate (800 mg) were added, consecutively, at a temperature of 40° C. Finally, the stained fabric was added and stirred for 30 mins (200 rpm) at a temperature of 40° C. After the bleaching, the bleached fabric pieces were washed with tap water for three times at ambient temperature, squeezed and dried naturally.

The bleaching performance was evaluated by CIELAB Color i7 spectrophotometer. Color difference (ΔE) before and after bleaching is calculated with:

$$Δ E = \sqrt{\begin{matrix}{( {l}_{bleached} - {l}_{original} )}^{2} + {( {a}_{bleached} - {a}_{original} )}^{2} + \\ {( {b}_{bleached} - {b}_{original} )}^{2}\end{matrix}}$$

Results with different stained fabrics and amine catalysts are expressed in Table 1.

TABLE 1

| | | ΔE (C-S49) | ΔE (EMPA) |
|---|---|---|---|
| | ΔE (C-H028) | (Coffee | (Red Lipstick |
| Bleaching agents | (Tea stained) | stained) | Stained) |
| Detergent (2.0 g) | 25.7 | 22 | 11.8 |
| TAED (400 mg) | | | |
| Sodium percarbonate | | | |
| (800 mg) | | | |
| Detergent (2.0 g) | 11.5 | 14.7 | 8.6 |
| Detergent (2.0 g) | 19.6 | 17.9 | 12.1 |
| Sodium percarbonate | | | |
| (800 mg) | | | |
| Detergent (2.0 g) | 28.5 | 21.4 | 15.5 |
| TMTACN (10 mg) | | | |
| Sodium percarbonate | | | |
| (800 mg) | | | |
| Detergent (2.0 g) | 21.2 | 19.6 | 11.1 |
| TMTACDD (10 mg) | | | |
| Sodium percarbonate | | | |
| (800 mg) | | | |
| Detergent (2.0 g) | 21.3 | 19.2 | 11.2 |
| TMTA (10 mg) | | | |
| Sodium percarbonate | | | |
| (800 mg) | | | |

Tea stained fabric reference: CFT B.V. C-H028 standard material Tea - Circular Stain
Ø = 5 cm on Woven Cotton
Coffee stain reference: CFT B.V. C-S49 standard material (Coffee, freshly brewn, black)
Red lipstick stained fabric: EMPA 141/1 standard soiled fabric.

It appears the composition of the invention permits to obtain very good bleaching properties on fabrics while using a significant lower amount of amine compound in comparison with TAED known as a reference on the market, with a weight ratio of 10/400.

### EXAMPLE 2

Into a beaker with 1L hard water (250 mg Ca/L) at 40° C., optionally 2.0 g of standard detergent GB/T 13174-2008 was added and the mixture was stirred for 3 mins, at a temperature of 40° C. The amine compound (10 mg) and sodium percarbonate (800 mg) were added, consecutively, at a temperature of 40° C. Finally, the stained fabric was added and stirred for 30 mins (200 rpm) at a temperature of 40° C. After the bleaching, the bleached fabric pieces were washed with tap water for three times at ambient temperature, squeezed and dried naturally.

Results with different stained fabrics and amine catalysts are expressed in Table 1.

TABLE 2

| | ΔE |
|---|---|
| Formulations | (Tea stained) |
| Water only | 2 |
| Water and detergent | 11.5 |
| Water, sodium percarbonate and no detergent | 14.3 |
| Water, TMTACN, sodium percarbonate and no detergent | 17.6 |

It appears the composition of the invention permits to obtain higher bleaching properties on fabrics without detergent in comparison with the bleaching agent alone.

### EXAMPLE 3

### The Procedure to Prepare the Homemade Tea&Coffee Stained Fabric

Tea&coffee stain solution was prepared as follows: 100 g green tea was put into the bottle with 1 L hot water for 30 mins, and then the solution was filtrated and mixed with 0.5 L black coffee solution.

Homemade tea&coffee stained fabric: The standard white woven cotton fabric (JB-00, GB13174-2008) was immersed into the stain solution for 5 mins and then squeezed and dried naturally.

### EXAMPLE 4

The homemade tea&coffee stained cotton fabric (25 cm*25 cm) prepared by Example 3 was put into the laundry machine (Haier XQBM20), standard detergent GB/T 13174-2008(2.0 g), sodium percarbonate (800 mg) and TMTACN (10 mg) were added, consecutively. The 2 L 40° C. water was poured inside the laundry machine and the program (low water level, 48 mins/cycle) was chosen. After the washing process, the fabric was dried naturally. Then the dried fabric was subjected to the next washing cycle.

After 3 cycles, the bleached fabric was stained again according the procedure to prepare the homemade tea&coffee stained cotton fabric. And after 6 cycles, the bleached and dried fabric was cut into 5 cm*5 cm pieces. The peak force to pierce at the middle of the fabric piece by a blunt metal bar was measured by a Newton meter in order to detect the fabric damage caused by the formulation. The result is 53.1 as shown in Table 3.

The fabric damage test indicated that the compound of formula (I) caused much less fabric damage than Dragon complex. The compound of formula (I) caused similar fabric damage as benchmark TEAD.

### Comparative Example 1

The procedure is the same with Example 4, but TMTACN was replaced by the Dragon complex (Catexel Company)(5 mg). The result is 43.1 as shown in Table 3.

### Comparative Example 2

The procedure is the same with Example 4, but TMTACN was replaced by the TAED (400 mg). The result is 53.7 as shown in Table 3.

### Comparative Example 3

The procedure is the same with Example 1, but without the sodium percarbonate and TMTACN. The result is 51.5 as shown in Table 3.

TABLE 3

| | | Peak force to |
|---|---|---|
| | Formulation | pierce the fabric |
| Example 4 | Detergent(2.0 g) | 53.1 |
| | Sodium percarbonate(800 mg) | |
| | TMTACN(10 mg) | |
| Comparative | Detergent(2.0 g) | 43.1 |
| Example 1 | Sodium percarbonate(800 mg) | |
| | Dragon complex(5 mg) | |
| Comparative | Detergent(2.0 g) | 53.7 |
| Example 2 | Sodium percarbonate(800 mg) | |
| | TAED(400 mg) | |
| Comparative | Detergent(2.0 g) | 51.5 |
| Example 3 | | |

### EXAMPLE 5

The components of the auto dishwashing (hereinafter ADW) formulation are presented in Table 4, and firstly the components in solid state (Trisodium citrate hexahydrate, sodium carbonate, sodium silicate, Mirapol® Surf-S Pfree Powder, sodium percarbonate, sodium sulfate) were mixed sufficiently and put into the ADW machine washing product chamber. Then the components in liquid form (Antarox LF54 and Rhodoline 111) were weighed into the rince aid chamber in ADW machine. After addition of the TMTACN and putting the tea stained tiles into the machine, the bleaching process began to work.

TABLE 4

| Component | g |
|---|---|
| Trisodium citrate hexahydrate (Sinopharm.) | 30 |
| Sodium carbonate (Sigma-Aldrich) | 20 |
| Sodium silicate (Sigma-Aldrich) | 10 |
| Mirapol ® Surf-S Pfree Powder (Solvay) | 1 |
| Sodium percarbonate (Alfa-Aesaer) | 8 |
| Rhodoline 111 (Solvay) | 8 |
| Antarox LF54 (Solvay) | 3 |
| Sodium sulfate (Sigma-Aldrich) | 10 |

### EXAMPLE 6

In the autodishwasher (SIMENS SE5P1S), 10 g homemade ADW formulation made by Example 5 and 10 mg TMTACN were added in the corresponding container. Then two pieces of the tea stained melamine tiles (CFT DM11) were put inside the autodishwasher, the program (40° C. for glassware) was chosen. After the bleaching process, the tea stained melamine tiles were measured by CIE i7 spectrophotometer to obtain the color difference before and after bleaching ΔE=8.4 as shown in Table 5.

### Comparative Example 4

The procedure was the same with Example 6, but without TMTACN, which afforded ΔE=5.1 as shown in Table 5.

### Comparative Example 5

The procedure was the same with Example 6, but 400 mg TAED was added and without TMTACN, which afforded ΔE=7.4 as shown in Table 5.

Obviously, the TMTACN increased significantly the bleaching performance of homemade ADW formulation and showed better performance than benchmark TAED.

### EXAMPLE 7

In the autodishwasher (SIMENS SE5P1S), 8 g Finish detergent (Reckitt Benckiser) and 10 mg TMTACN were added in the corresponding container. Then two pieces of the tea stained melamine tiles (CFT DM11) were put inside the autodishwasher, the program (40° C. for glassware) was chosen. After the bleaching process, the tea stained melamine tiles were measured by CIE i7 spectrophotometer to obtain the color difference before and after bleaching ΔE=9.7 as shown in Table 5.

### Comparative Example 6

The procedure is the same with Example 7, but without 10 mg TMTACN was added in the Finish® detergent, which afforded ΔE=8.6 as shown in Table 5.

It appears that the presence of TMTACN increased the bleaching performance of Finish® detergent.

### EXAMPLE 8

In the autodishwasher (SIMENS SE5P1S), 800 mg sodium percarbonate and 10 mg TMTACN were added in the corresponding container. Then two pieces of the tea stained melamine tiles (CFT DM11) were put inside the autodishwasher, the program (40° C. for glassware) was chosen. After the bleaching process, the tea stained melamine tiles were measured by CIE i7 spectrophotometer to obtain the color difference before and after bleaching ΔE=4.8 as shown in Table 5.

### Comparative Example 7

The procedure is the same with Example 8, but without 10 mg TMTACN, which afforded ΔE=2.7 as shown in Table 5.

It appears that the presence of TMTACN increased the bleaching performance of formulation comprising sodium percarbonate.

TABLE 5

| | Formulation | ΔE |
|---|---|---|
| Example 6 | Homemade ADW formulation(10.0 g) | 8.4 |
| | TMTACN(10 mg) | |
| Comparative | Homemade ADW formulation(10.0 g) | 5.1 |
| Example 4 | | |
| Comparative | Homemade ADW formulation(10.0 g) | 7.4 |
| Example 5 | TAED(400 mg) | |
| Example 7 | Finish ® detergent(8.0 g) | 9.7 |
| | TMTACN(10 mg) | |
| Comparative | Finish ® detergent(8.0 g) | 8.6 |
| Example 6 | | |
| Example 8 | Sodium percarbonate(800 mg) | 4.8 |
| | TMTACN(10 mg) | |
| Comparative | Sodium percarbonate(800 mg) | 2.7 |
| Example 7 | | |

1. A composition, comprising at least:
a) a compound of formula (I) 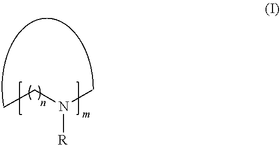
wherein:
R is a hydrocarbyl radical, and each of the R groups may be the same or different,
n is 1, 2 or 3,
m is 2, 3, 4 or 5; and
b) a source of hydrogen peroxide.

2. (canceled)

3. (canceled)

4. The composition according to claim 1, wherein the compound of formula (I) is selected from the group consisting of triazacycloalkanes and tetraazacycloalkanes.

5. The composition according to claim 1, wherein the compound of formula (I) is selected from the group consisting of 1,3,5-trimethyl-1,3,5-triazacyclohexane, 1,3,5-trimethyl-1,3,5-triazepane, 1,3,5-trimethyl-1,3,5-triazocane, 1,3,5,7-tetramethyl-1,3,5-triazocane, 1,3,6-trimethyl-1,3,6-triazocane, 1,3,5-trimethyl-1,3,5-triazonane, 1,3,6-trimethyl-1,3,6-triazonane, 1,3,6,8-tetramethyl-1,3,6-triazonane, 1,4,7-trimethyl-1,4,7-triazacyclononane, 1,3,5-trimethyl-1,3,5-triazecane, 1,3,6-trimethyl-1,3,6-triazecane, 1,3,7-trimethyl-1,3,7-triazecane, 1,3,5,7-tetramethyl-1,3,7-triazecane, 1,3,5,7,9-pentamethyl-1,3,7-triazecane, 1,3,5,7-tetramethyl-1,3,5-triazecane, 1,4,7-trimethyl-1,4,7-triazecane, 1,4,7,9-tetramethyl-1,4,7-triazecane, 1,4,7-trimethyl-1,4,7-triazacycloundecane, 1,4,8-trimethyl-1,4,8-triazacycloundecane; 1,4,6,8-tetramethyl-1,4,8-triazacycloundecane, 1,4,7-trimethyl-1,4,7-triazacyclododecane, 1,4,7,10-tetramethyl-1,4,7,10-tetraazacyclododecane; 1,4,7,10-tetramethyl-1,4,7-triazacyclododecane, 1,4,8-trimethyl-1,4,8-triazacyclododecane, 1,5,9-trimethyl-1,5,9-triazacyclododecan, 1,3,5,9-tetramethyl-1,5,9-triazacyclododecane, and 2-methyl-1,4,7-trimethyl-1,4,7-triazacyclononane.

6. The composition according to claim 1, wherein the compound of formula (I) is present in the composition in an amount from 0.0001 to 1.0% by weight, with respect to the total weight of the composition.

7. The composition according to claim 1, wherein the source of hydrogen peroxide is selected from the group consisting of alkali metal peroxides, organic peroxides, inorganic persalts and their precurors.

8. The composition according to claim 1, wherein the composition comprises from 1 to 30% by weight of the source of hydrogen peroxide, with respect to the total weight of the composition.

9. (canceled)

10. (canceled)

11. (canceled)

12. The composition according to claim 1, wherein the composition is completely free of any transition metal catalysts.

13. The composition according to claim 1, wherein the composition comprises from 0 to 0.001% by weight of transition metal catalysts, based on the total weight of the composition.

14. A formulation comprising at least a detergent, a compound of formula (1): 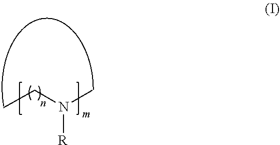
wherein:
R is a hydrocarbyl radical, and each of the R groups may be the same or different,
n is 1, 2 or 3, and
m is 2, 3, 4 or 5, and optionally, a source of hydrogen peroxide.

15. The formulation according to claim 14, wherein the formulation is a solid composition, said composition comprises from 0.1 to 2% by weight of compound of formula (I) with respect to the total weight of the composition.

16. A composition kit, comprising at least:
a first component, comprising at least a detergent and a compound of formula (I): and 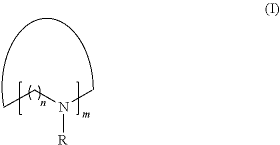
wherein:
R is a hydrocarbyl radical, and each of the R groups may be the same or different,
n is 1, 2 or 3, and
m is 2, 3, 4 or 5, and
a second component, comprising at least a source of hydrogen peroxide, wherein the second component is separate from the first component and is capable of being mixed with the first component to form the composition.

17. (canceled)

18. (canceled)

19. (canceled)

20. A method for treating a substrate, comprising applying to the substrate, in an aqueous medium, a composition comprising at least a compound of formula (I): 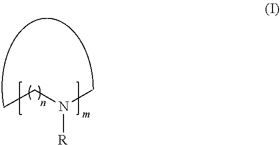
wherein:
R is a hydrocarbyl radical, and each of the R groups may be the same or different,
n is 1, 2 or 3, and
m is 2, 3, 4 or 5.

21. The method of claim 20, wherein the substrate comprises tableware

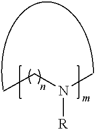

22. (canceled)

23. (canceled)

24. (canceled)

25. (canceled)

26. The composition according to claim 7, wherein the source of hydrogen peroxide comprises urea peroxide or an inorganic persalt selected from the group consisting of alkali metal perborates, percarbonates, perphosphates, persulphates and peroxyacids, their salts, and their precurors.
